(19) United States
(12) Patent Application Publication
(10) Pub. No.: US 2025/0007385 A1
(43) Pub. Date: Jan. 2, 2025

(54) ANPC POWER MODULE

(71) Applicant: SHANGHAI METAPWR ELECTRONICS CO., LTD, Shanghai (CN)

(72) Inventors: Shouyu Hong, Shanghai (CN); Xiaoni Xin, Shanghai (CN); Jiaoping Huang, Shanghai (CN); Dong Xu, Shanghai (CN); Hong Jiang, Shanghai (CN)

(73) Assignee: SHANGHAI METAPWR ELECTRONICS CO., LTD, Shanghai (CN)

(21) Appl. No.: 18/755,682

(22) Filed: Jun. 27, 2024

(30) Foreign Application Priority Data
Jun. 29, 2023 (CN) 202310779775.2
Jan. 22, 2024 (CN) 202410087119.0

(51) Int. Cl. H02M 1/00; H02M 1/44; H02M 7/00; H02M 7/5387

(52) U.S. Cl. CPC H02M 1/0095; H02M 1/44; H02M 7/003; H02M 7/53871

(57) ABSTRACT

The application discloses an ANPC power module. at least one power module, wherein the power module comprises six switch assemblies, a DC end, a GND end and an SW end, the six switch assemblies comprise two outer switches, two inner switches and two clamping switches, wherein an additional capacitor lead-out terminal is arranged at an electrical connection of each of the two inner switches and the two switch bridge arms, the capacitor lead-out terminal is used for setting a high-frequency filter capacitor, and two ends of the high-frequency filter capacitor are electrically connected with the capacitor lead-out terminals corresponding to the two switch bridge arms respectively. The application can effectively improve the instantaneous dynamic voltage spike of the high-frequency switching action, improve the oscillation frequency, increase the working voltage range of the device, and prevent the EMI noise from interference the devices outside of the ANPC power module.

### CROSS-REFERENCE TO RELATED APPLICATION

This application claims the priority benefit of China application no. 202310779775.2, filed on Jun. 29, 2023, and China application no. 202410087119.0, filed on Jan. 22, 2024. The entirety of the above-mentioned patent application is hereby incorporated by reference herein and made a part of this specification.

### BACKGROUND

### Technical Field

Compared with a traditional NPC (Neutral Point Clamped) converter, an ANPC (Active Neutral Point Clamped) converter adopts a fully-controlled switch assembly (and a freewheeling diode thereof) to replace a diode to realize middle point clamping, so that the freedom of system control is improved. In the single module, the switch connected with the positive and negative electrodes on the direct-current side is called an outer switch, the switch connected with the alternating-current side is called an inner switch, and the switch connected with the neutral point on the direct-current side is called as a clamping switch.

Due to the fact that the ANPC has six full-control type devices at different positions, a driving control scheme in various modes is disposed. However, due to the limitation of a single device and the control limitation, the loss balance of devices at each position cannot be realized;

The application of the high-power system, the voltage, the current, the frequency and other specifications of the power device are continuously improved. In terms of the power module, the size and the number of the device is also gradually increased, so that the path of the power loop is lengthened and widened. According to the traditional DC Link capacitance filtering design, due to the fact that the distance is too far, the characteristic is poor, an ideal filtering effect cannot be achieved, the high-frequency switching action easily causes too high voltage spike, and the actual working voltage range is limited; and the EMC of the system brings significant negative influence, and the working voltage range cannot be optimized.

Therefore, how to suppress driving interference while applying capacitance filtering, reduce the cost and power space, and improve the overall performance of the device is an urgent problem to be solved.

### SUMMARY

An ANPC power module comprises at least one power module, wherein the power module comprises six switch assemblies, a DC end, a GND end and an SW end, each switch assembly comprises at least one switch component, the six switch assemblies comprise two outer switches, two inner switches and two clamping switches, each DC end comprises a DC positive terminal and a DC negative terminal, each outer switch and the corresponding clamping switch are connected in series to form a switch bridge arm, the two ends of the switch bridge arm are electrically connected with the GND end and one DC terminal respectively. The midpoint of each of the two switch bridge arms is electrically connected with a first end of the two inner switches. A second end of the two inner switches is electrically connected with the SW end.
wherein the switch component included in each of the two clamping switches is an IGBT device, a switch component included in each of the two outer switches is an IGBT device, and a switch component included in each of the two inner switches is a wide-bandgap device;
an additional capacitor lead-out terminal is arranged at the electrical connection of each inner switch and the switch bridge arm, the capacitor lead-out terminal is used for setting a high-frequency filter capacitor, and the two ends of the high-frequency filter capacitor are electrically connected with the capacitor lead-out terminals corresponding to the two switch bridge arms respectively.

Preferably, an additional diversion lead-out terminal is arranged at the two ends of each switch bridge arm respectively, and the diversion lead-out terminal is used for arranging an additional diversion path outside the ANPC power module;
wherein the diversion path is connected in parallel with an electrical connection path from a switch bridge arm arranged inside the ANPC power module to a GND end, or the diversion path is connected in parallel with an electrical connection path from a switch bridge arm arranged inside the ANPC power module to a DC terminal.

Preferably, wherein each of the two inner switches comprises a first inner switch and a second inner switch, each of the two switch bridge arms comprises a first switch bridge arm and a second switch bridge arm, the SW end comprises an SW1 end and an SW2 end, one end of the first switch bridge arm is electrically connected with the DC positive terminal, and one end of the second switch bridge arm is electrically connected with the DC negative terminal;
one end of the first inner switch is electrically connected with the midpoint of the first switch bridge arm, and the other end of the first inner switch is electrically connected with the SW1 end; one end of the second inner switch is electrically connected with the midpoint of the second switch bridge arm, and the other end of the second inner switch is electrically connected with the SW2 end.

Preferably, wherein the DC positive terminal, the GND end and the DC negative terminal are sequentially arranged in the horizontal direction on the upper side of the ANPC power module;
wherein the outer switches and the clamping switches are arranged in an array in the horizontal direction, each of the outer switches is arranged at the position adjacent to the corresponding DC terminal, and each of the clamping switches is arranged at the position close to the GND end;
wherein the inner switches are arranged in a row in the horizontal direction, and each of the inner switches is arranged at the position adjacent to the corresponding switch bridge arm;
wherein the SW ends are arranged side by side in the horizontal direction on the lower side of the inner switches.

Preferably, wherein at least one of the six switch assemblies comprises at least two switch components, and the switch components included in the same switch assemblies are connected in parallel.

Preferably, wherein each of the inner switches comprises a plurality of wide band gap devices inner switch, the wide band gap devices in the same inner switch are connected in parallel forming at least one parallel point, and the lengths of the equivalent electrical connection path from each wide band gap device to the corresponding parallel bus point are the same.

Preferably, wherein each of the outer switches further comprises at least two power diodes, and the power diodes and the IGBT device in the same outer switch are arranged in a hybrid array.

Preferably, wherein the hybrid array is arranged in a long-strip-shaped array, and the power diodes are evenly arranged on the two sides of the IGBT device in the long direction of the long-strip-shaped.

Preferably, the number of the diversion lead-out terminals is at least one, and the diversion lead-out terminal is further used for arranging an additional filtering loop outside the ANPC power module.

Preferably, the number of the wide bandgap devices included in each inner switch is multiple, the wide bandgap devices included in the same inner switch are connected in parallel, and the difference of the lengths of the equivalent electrical connection paths from each wide bandgap device to the corresponding parallel bus point does not exceed 20%.

Preferably, wherein a switch component included in each of the inner switches further comprises an IGBT device, and the switch components of each of the outer switches, the clamping switches and the inner switches are also connected respectively with a power diode in parallel.

Preferably, the number of IGBT devices included in each inner switch is multiple, the IGBT devices included in the same inner switch are connected in parallel, and the lengths of the equivalent electrical connection path from each IGBT device to the corresponding parallel bus point are the same.

Preferably, the number of IGBT devices included in each inner switch is multiple, the IGBT devices included in the same inner switch are connected in parallel, and the difference of the lengths of the equivalent electrical connection paths from each IGBT devices to the corresponding parallel bus point does not exceed 20%.

Preferably, the ANPC power module further comprising:
a module substrate, comprises a first surface and a second surface which are opposite to each other;
a power chip, comprises an input end and an output end, and the power chip is arranged on the first surface of the module substrate;
a packaging part, wherein the packaging part comprises a glue filling space, and the glue filling space wraps a power chip and a first surface of the module substrate;
a power loop, used for electrically connecting the input end and the output end of the power chip.

Preferably, wherein the power loop comprises a vertical loop and a connection loop, and the vertical loop is used for supporting, fixing and connecting the connection loop.

Preferably, the power loop is arranged in the glue filling space, the connection loop comprises a functional board, the vertical loop comprises the capacitor lead-out terminal, and the capacitor lead-out terminal comprises a long connection terminal and a short connection terminal;
wherein the functional board is arranged above the first surface of the module substrate, the short connection terminal penetrates through the functional board, the functional board is connected with the module substrate, the long connection terminal penetrates through a module cover plate, and the client mainboard is connected with the module substrate;
wherein the functional board comprises a high-frequency decoupling capacitor or a high-frequency filtering capacitor.

Preferably, wherein the short connection terminal comprises a first short connection terminal, the first short connection terminal is used for realizing electrical connection, and the position of the functional board is cladded with the first short connection terminal in the vertical direction.

Preferably, wherein the short connection terminal further comprises a second short connection terminal, the second short connection terminal is not used for electrical connection, and the position of the function board is further cladded with a second short connection terminal in the vertical direction.

Preferably, wherein the module substrate is divided into nine-grid, and the areas of each grid are equal;
in the vertical direction, the functional board is provided with an opening hole in a region corresponding to each grid, and the area of the opening hole is not less than 10% of the area of each grid.

Preferably, a boss is arranged in the central section of the short connection terminal, and the boss is used for supporting the functional board.

Preferably, wherein the connection loop comprises a client mainboard, and the vertical loop is the capacitor lead-out terminal;
wherein the capacitor lead-out terminal is used for electrically connecting the client mainboard and the module substrate.

A manufacturing method of the ANPC power module is comprises the following steps:
Step 1: providing a substrate and the ANPC power module;
Step 2: connecting the ANPC power module with the substrate;
Step 3: installing a module shell, filling the glue between the module shell and the substrate, and removing bubbles and curing to form a glue filling space;
Step 4: mounting a module cover plate to the ANPC power module.

Preferably, steps further comprising the step before the step 3:

a heat conducting connecting plate is provided, the heat conducting connecting plate is arranged below the substrate, and the heat conducting connecting plate is welded to be fixedly and thermally connected with the substrate.

Preferably, wherein the step 2 comprises:
Firstly, the capacitor lead-out terminal is arranged at a corresponding position and is welded, and then the power chip is arranged at a corresponding position and welded; or,
Firstly, the power chip of the ANPC power module is arranged at a corresponding position and is welded, and then the capacitor lead-out terminal of the ANPC power module is arranged at a corresponding position and welded; or,
the power chip of the ANPC power module and the capacitor lead-out terminal of the ANPC power module are arranged at corresponding positions and then welded together.

The manufacturing method of the ANPC power module comprises the following steps:
Step 1: providing a substrate, a power chip and the capacitor lead-out terminal;
Step 2: respectively connecting the substrate, the power chip and the capacitor lead-out terminal;
Step 3: providing a functional board, and welding the functional board and the short connection terminal;
Step 4: mounting a module shell, filling the glue between the module shell and the substrate, removing bubbles and curing to form a glue filling space, wherein the height of the glue filling space at least covers the functional plate;
Step 5: mounting the module cover plate to form the ANPC power module.

The manufacturing method further comprises the following step before the step 4:

a heat conducting connecting plate is provided, the heat conducting connecting plate is arranged below the substrate, and the heat conducting connecting plate is welded to be fixedly and thermally connected with the substrate.

Preferably, wherein the step 2 comprises:
Firstly, the capacitor lead-out terminal is arranged at a corresponding position and is welded, and then the power chip is arranged at a corresponding position and welded; or,
Firstly, the power chip is arranged at a corresponding position and is welded, and then the capacitor lead-out terminal is arranged at a corresponding position and welded; or,
the power chip of the ANPC power module and the capacitor lead-out terminal of the ANPC power module are arranged at corresponding positions and then welded together.

An application of manufacturing method applied in a half-bridge, full-bridge, three-phase bridge, TNPC, DNPC or INPC power module.

An operating method of the capacitor lead-out terminal in a half-bridge, full-bridge, three-phase bridge, TNPC, DNPC or INPC power module.

An operating method of the aforementioned ANPC power module, the two ends of at least one high-frequency filter capacitor are electrically connected with the capacitor lead-out terminals of the power module respectively, the equivalent capacitance of the high-frequency filter capacitor is at least C, and C meets the formula (1):

$$\frac{1}{2} {LI}^{2} = \frac{1}{2} {CU}_{MAX}^{2} - \frac{1}{2} {CU}^{2} \qquad ( 1 )$$

L is an equivalent inductance of a power loop when the ANPC power module is applied, i is a current value at the turn-off moment, Umax is a maximum voltage value, and U is a working voltage value.

The beneficial effects of the application are that:
(1) An additional capacitor lead-out terminal is arranged at the electrical connection of each inner switch and the switch bridge arm, and after the high-frequency filter capacitor is externally connected, the voltage stress of the device can be improved, and the noise under the action of the high-frequency switch can be inhibited;
(2) A diversion lead-out terminal outside the main power loop is arranged at the two ends of each switch bridge arm respectively, an additional diversion path and a filter loop can be arranged to improve the path, optimize the loop parasitic parameters, improve the voltage stress of the device and inhibit the action noise of the high-frequency switch;
(3) The length of the equivalent electric connection path of the bus point in parallel connection with the position of the internal device of the inner pipe is kept consistent, so that the dynamic current sharing effect under the parallel connection of multiple devices is achieved, the power diode is arranged in the outer switch in a mixed array mode, the heat distribution of the diode and the switch tube can be effectively dispersed, and therefore the effect of optimizing the heat dissipation design of the module is achieved.
(4) Another intelligent module is provided, the voltage stress of the device can be further improved, high-frequency EMC noise is inhibited, the working voltage of the system is expanded, and a manufacturing method is provided.

### BRIEF DESCRIPTION OF THE DRAWINGS

FIG. 1 is a schematic diagram of a circuit according to an embodiment.

FIG. 2 and FIG. 3 are schematic structural diagrams of an embodiment.

FIG. 4 is a schematic diagram of a third loop according to an embodiment.

FIG. 5 and FIG. 6 are partial enlarged schematic diagrams of an outer switch and an inner switch according to an embodiment.

FIG. 7 is a partial enlarged schematic diagram of an inner switch and an SW end according to an embodiment.

FIG. 8 is a schematic diagram of an internal structure of an outer switch according to an embodiment.

FIG. 9A, FIG. 9B, FIG. 10A, FIG. 10B, FIG. 10C, FIG. 11A, FIG. 11B, FIG. 11C, and FIGS. 12-15 are schematic diagrams of Embodiment 2.

### DESCRIPTION OF THE EMBODIMENTS

The present application discloses various embodiments or examples of implementing the thematic technological schemes mentioned. To simplify the disclosure, specific instances of each element and arrangement are described below. However, these are merely examples and do not limit the scope of protection of this application. For instance, a first feature recorded subsequently in the specification formed above or on top of a second feature may include an embodiment where the first and second features are formed through direct contact, or it may include an embodiment where additional features are formed between the first and second features, allowing the first and second features not to be directly connected. Additionally, these disclosures may repeat reference numerals and/or letters in different examples. This repetition is for brevity and clarity and does not imply a relationship between the discussed embodiments and/or structures. Furthermore, when a first element is described as being connected or combined with a second element, this includes embodiments where the first and second elements are directly connected or combined with each other, as well as embodiments where one or more intervening elements are introduced to indirectly connect or combine the first and second elements.

One of the cores of the application is to provide the ANPC power module, which can effectively improve the instantaneous dynamic voltage spike of the high-frequency switching action, improve the oscillation frequency, increase the working voltage range of the device, and prevent the EMI noise from interference the devices outside of the ANPC power module.

### Embodiment 1

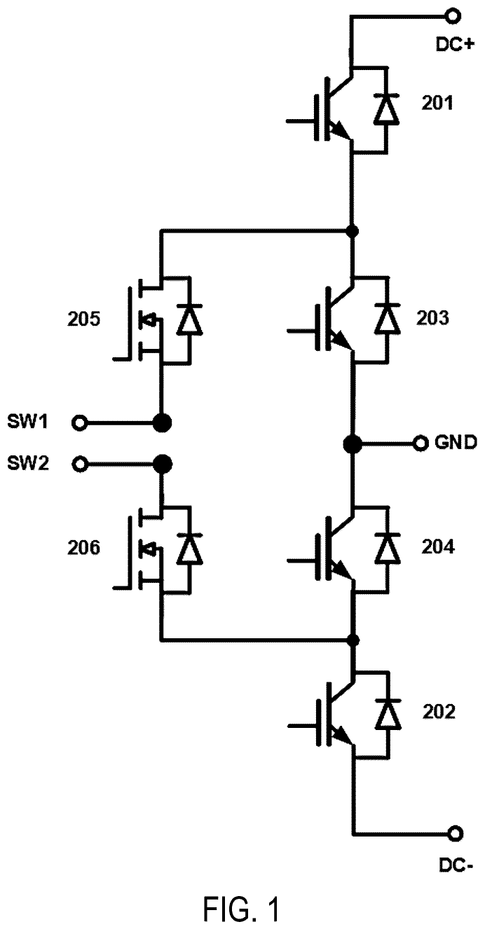

As shown in FIG. 1, the embodiment of the application comprises six switch assemblies, a DC end, a GND end and an SW end (in some embodiments, further comprising a power terminal and a signal control terminal corresponding to the switch assembly). The six switch assemblies comprise two outer switches 201/202, two inner switches 205/206 and two clamping switches 203/204 (each switch of the outer switches, the inner switches and the clamping switches is formed multiple switch components by connecting in parallel). The DC end comprises a DC positive terminal and a DC negative terminal (DC+ and DC−). The SW end comprises an SW1 end and an SW2 end. The outer switch 201 and the clamp switch 203 are connected in series to form a first switch bridge arm; the two ends of the first switch bridge arm are electrically connected with the GND end and the DC positive terminal respectively; the midpoint of the bridge arm of the first switch bridge arm is electrically connected with the inner switch 205, and the other end of the inner switch 205 is electrically connected with the SW1 end. The outer switch 202 and the clamp switch 204 are connected in series to form a second switch bridge arm; the two ends of the second switch bridge arm are electrically connected with the GND end and the DC negative terminal respectively; the midpoint of the bridge arm of the switch bridge arm is electrically connected with the inner switch 206, and the other end of the inner switch 206 is electrically connected with the SW2 end.

In the embodiment of the application, the inner switch 205/206 is used for high-frequency switching action, the outer switch 201/202 and the clamping switch 203/204 are used for low-frequency switching action. The clamping switch 203/204 and the outer switch 201/202 are IGBT devices with better on-state characteristics when it works at low-frequency. The inner switch 205/206 is a wide bandgap (WBG) device with better high-frequency characteristics, such as SiC or GaN device.

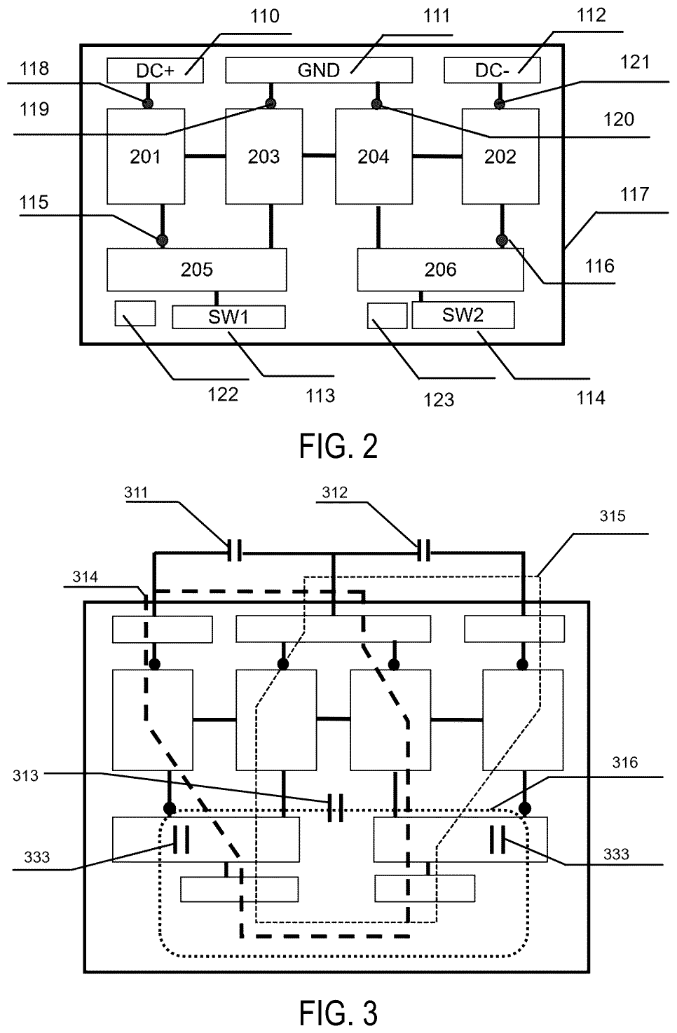

FIG. 2 shows the layout of the ANPC power module according to the embodiment, and the structure of the ANPC power module is described in sequence from top to bottom.

The first level comprises a power connection terminal, and specifically comprises a DC positive terminal 110, a GND end 111 and a DC negative terminal 112. The DC positive terminal 110, the GND end 111 and the DC negative terminal 112 are sequentially arranged in the horizontal direction.

The second level comprises an outer switch 201, a clamping switch 203, a clamping switch 204 and an outer switch 202. The outer switch 201, the clamping switch 203, the clamping switch 204 and the outer switch 202 are sequentially arranged in the horizontal direction.

A diversion lead-out terminal 118/119/120/121 is arranged on the power wiring path between the first level and the second level.

The third level comprises an inner switch 205 and an inner switch 206, the inner switch 205/206 is arranged in a row in the horizontal direction, and the inner switch 205/206 is arranged at the position adjacent to the corresponding switch bridge arm.

A capacitor lead-out terminal 115 is provided at a position of a connection path between the outer switch 201 and the inner switch 205 and the position is close to the inner switch 205, and a capacitor lead-out terminal 116 is provided at a position of a connection path between the outer switch 202 and the inner switch 206 and the position is close to the inner switch 206.

The fourth level comprises the SW1 end and the SW2 end of the power connection terminal, and alternating currents flow through the SW1 end and the SW2 end. The SW1 end is electrically connected with the other end of the inner switch 205, and the SW2 end is electrically connected with the other end of the inner switch 206.

The four levels are arranged on a substrate 117, and the outer switch 201 is electrically connected with the DC positive terminal 110, the clamping switch 203 and the inner switch 201 through the substrate 117.

The clamping switch 203 is electrically connected with the GND end 111, the outer switch 201, the clamping switch 202 and the inner switch 201 through the substrate 117.

The clamping switch 204 is electrically connected with the GND end 111, the outer switch 202, the clamping switch 203 and the inner switch 206 through the substrate 117.

The outer switch 202 is electrically connected with the DC negative terminal 112, the clamping switch 204 and the inner switch 206 through the substrate 117.

The inner switch 205 is electrically connected with the outer switch 201, the clamping switch 203 and the SW1 end through the substrate 117.

The inner switch 206 is electrically connected with the outer switch 202, the clamping switch 204 and the SW2 end through the substrate 117.

The GND end 111 is electrically connected with the clamping switch 203 and the clamping switch 204, and the clamping switch 203 is electrically connected with the clamping switch 204.

In the embodiment, the substrate 117 is further provided with a high-frequency driving port 122 of the inner switch 205/206. The high-frequency driving port of the inner switch 205 is located in the left side area of the SW1 end. The high-frequency driving port 122 of the inner switch 206 is located in the left side area of the SW2 end.

In the embodiment, the capacitor lead-out terminals 115/116 are not directly electrically connected with the wire in the substrate, and are electrically connected through an external high-frequency filter capacitor. A person skilled in the art can set the capacitance of the high-frequency filter capacitor according to the following description method.

The SW1 end and the SW2 end of the embodiment are independent of each other in the ANPC power module. They are electrically connected through the external of the ANPC power module in the embodiment, or electrically connected through the internal of the ANPC power module in other embodiments.

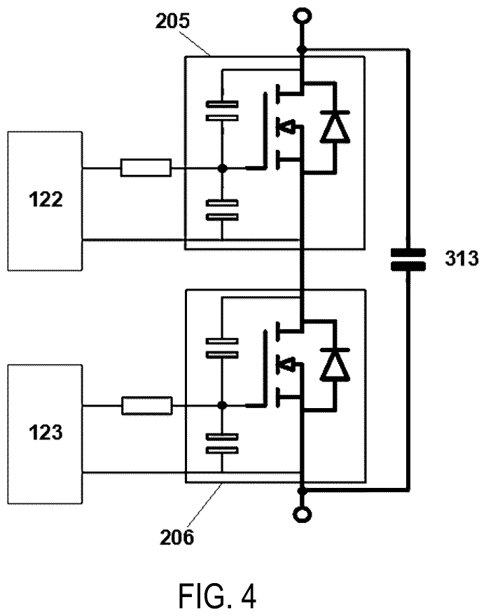

When the ANPC power module is applied, as shown in FIG. 3 and FIG. 4, after the SW1 end and the SW2 end are electrically connected, the DC link capacitor 311 (which may be a capacitor device or multiple capacitors in parallel) is arranged between the DC positive terminal 110 and the GND end 111. The other DC link capacitor 312 is arranged between the DC negative terminal 112 and the GND end 111 (It's a conventional arrangement that the two DC link capacitors are arranged in the external of the ANPC power module such as a system mainboard). In a traditional application, two loops exist in a positive half cycle and a negative half cycle working mode, one of which is a first loop 314 and the other of which is a second loop 315. The first loop 314 is formed by the DC link capacitor 311, the DC positive terminal 110, the outer switch 201, the inner switch 205, the SW1 end, the SW2 end, the clamp switch 204 and the GND end 111. The second loop 315 is formed by the DC link capacitor 312, the DC negative terminal 112, the outer switch 202, the inner switch 206, the SW2 end, the SW1 end, the clamp switch 203 and the GND end 111.

In the high-frequency working mode, the outer switch 201/202 and the clamping switch 203/204 both work in the power frequency mode and do not generate a high-frequency switching action. Due to the existence of the outer switch 201/202 and the clamping switch 203/204, the length of the high-frequency oscillation path is increased, and meanwhile high-frequency noise interference is caused.

In order to solve the problem, the ANPC power module further comprises the capacitor lead-out terminal 115/116. When the ANPC power module is applied, the high-frequency filtering capacitor 333 (which can be a capacitor or multiple capacitors in parallel) is arranged between the capacitor lead-out terminals 115 and 116. The high-frequency filtering capacitor 333, the inner switch 206, the SW1 end and the SW2 end form a third loop 316. The third loop 316 is shown in FIG. 4, the parasitic capacitance of the device can be ignored compared with the capacitance of the external capacitor, so that the equivalent capacitance of the third loop 316 is determined by the capacitance value of the external capacitor. Compared with the path length of the first loop 314 and the second loop 315, the path length of the third loop 316 is greatly reduced, the instantaneous dynamic voltage spike caused by the switching action of the high-frequency switch can be effectively improved, the oscillation frequency is improved, the working voltage range of the device can be widened, and the EMI noise interference can be prevented.

For the capacitance selection of the high-frequency filter capacitor 333, the upper and lower limitations can be determined according to the method. The lower limitation of the capacitance of the high-frequency filter capacitor 333 should effectively suppress voltage spikes. The calculation of the capacitance can be carried out according to the formula (1),

$$\frac{1}{2} {LI}^{2} = \frac{1}{2} {CU}_{MAX}^{2} - \frac{1}{2} {CU}^{2} \qquad ( 1 )$$

C is the lower limitation of the capacitance of the high-frequency filter capacitor 333. L is the equivalent inductance of the power loop, namely the parallel equivalent parasitic inductance of the first loop 314 and the second loop 315. i is the current value at the turn-off moment. Umax is the maximum voltage value, and U is the working voltage value.

The upper limitation of the capacitance of the high-frequency filter capacitor 333 is determined according to the charging process of the capacitor, and the impact current generated by the voltage difference between the initial voltage of the capacitor and the half of bus voltage should not damage the power devices and the capacitors in the loop (the first loop 314 and the second loop 315). A person skilled in the art can set a suitable capacitance of the high-frequency filter capacitor 333 according to actual conditions, for example, set to be closer to the lower limitation to meet the requirements.

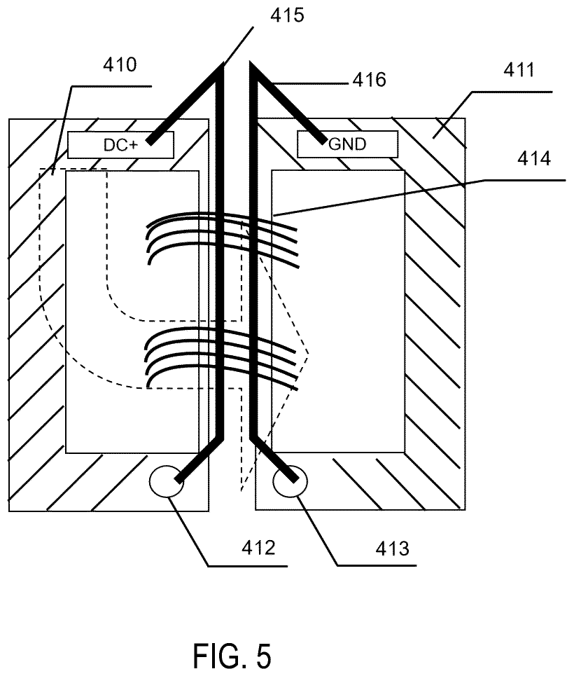

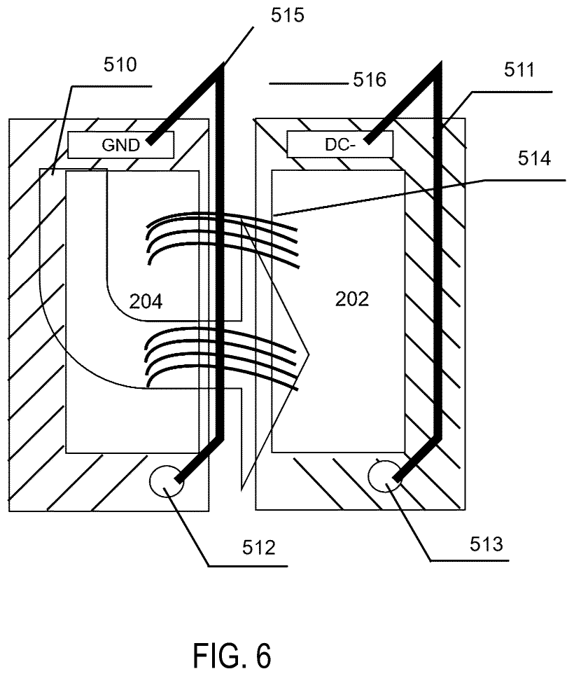

In some embodiments, as shown in FIG. 5 and FIG. 6, the pins of the switch assembly are arranged in the direction away from the corresponding terminals, and the copper foil wires of the substrate 117 are required to realize flow guiding.

In FIG. 5, the shadow area 410 is a copper foil diversion path of the DC positive terminal at the position of the outer switch 201.

The shadow area 411 is a copper foil diversion path of the GND end at the position of the clamping switch 203.

412 is a diversion lead-out terminal of the DC positive terminal at the position of the outer switch 201.

413 is a diversion lead-out terminal of the GND end at the clamping switch 203.

414 is a binding line WB between the outer switch 201 and the clamping switch 203.

415 is a diversion path of the main board of the system which is additionally arranged at the DC positive terminal at the position of the outer switch 201.

416 is a diversion path which is additionally arranged at the GND end and flows through the main board of the system at the position of the clamping switch 203.

Under the condition that the length of the original copper foil diversion path cannot be shortened, big parasitic parameters can be generated. According to the embodiment, by adding the lead-out terminal 415, a DC+ diversion path can be newly added to the system mainboard, and parasitic parameters of the DC+ loop are reduced through parallel connection of the diversion paths. By adding the lead-out terminal 416, a GND diversion path can be newly added to the system mainboard, and parasitic parameters of the GND loop are reduced through parallel connection of the diversion paths.

In FIG. 6, the shadow area of 510 is a copper foil diversion path of GND at the position of the clamping switch 204.

The shadow area 511 is a copper foil diversion path of the DC negative terminal at the position of the outer switch 202.

512 is a diversion lead-out terminal of the GND end at the position of the clamping switch 204.

513 is a diversion lead-out terminal of the DC negative terminal at the position of the outer switch 202.

514 is a binding line WB between the outer switch 202 and the clamping switch 204.

515 is a diversion path of the GND end which is additionally arranged at the clamping switch 204 flowing through the system mainboard;

516 is a diversion path of the DC negative terminal which is additionally arranged at the outer switch 202 flowing through the system mainboard;

According to the embodiment of the application, by adding the lead-out terminal 515, a GND diversion path can be newly added to the system mainboard, and parasitic parameters of the GND loop are reduced through parallel connection of the diversion paths. By adding lead-out terminal 516, a DC diversion path can be newly added to the system mainboard, and parasitic parameters of the DC loop are reduced through parallel connection of the diversion paths.

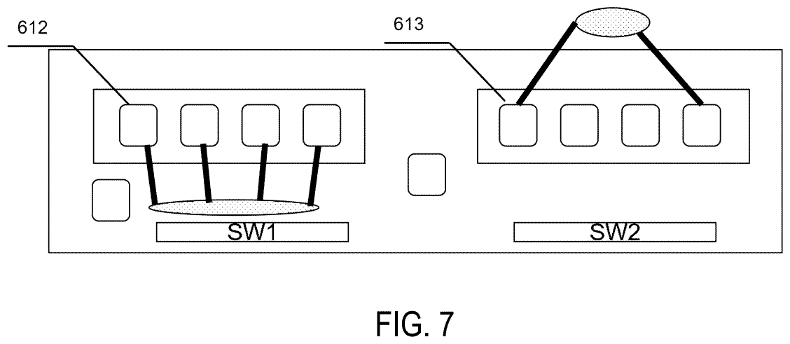

FIG. 7 is a partial enlarged view of the ends of the inner switches 205/206, SW1 and SW2. The inner switch 205 and the inner switch 206 are respectively a multi-device structure arranged on the DBC and are arranged in a same direction. The inner switch 205 and the inner switch 206 can be connected in parallel with two, three or four internal components 612/614 of the same specification. The high-frequency driving port 122 of the inner switch 205 is located in the left side region of the SW1 end. The high-frequency driving port 123 of the inner switch 206 is located in the left side region of the SW2 end. Due to the fact that the inner switches 205/206 are of a plurality of devices which are connected in parallel, corresponding confluence points exist in the circuit. In order to achieve the dynamic current sharing effect under the parallel connection of multiple devices, the length of the equivalent electrical connection path lengths from each device to the confluence point can be set to be consistent, or the proportion of the lengths is in a range close to 1. Preferably, the confluence points are aligned with the centers of the corresponding component positions.

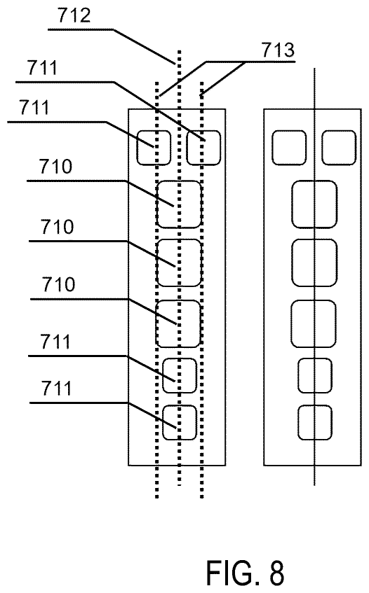

An internal structure of the outer switch 201/202 is shown in FIG. 8. The outer switch 201/202 generally comprises an IGBT 710 and a power diode 711 in anti-parallel connection with the IGBT 710. The outer switch 201/202 works in an inversion mode in a portion interval and works in the rectification mode in the other portion interval. In the inversion mode, the IGBT 710 is the main heat source. In the rectification mode, the power diode 711 is the main heat source. In order to optimize heat dissipation, the two types of components can be mixed and arranged in an array mode.

In a preferred embodiment, the hybrid arrays are arranged in a rectangular array. The IGBT 710 are arranged in parallel at the center of the outer switches, and the number of the IGBT 710 can be increased or decreased according to the size of the power module. The power diode 711 is evenly placed on the two sides of the IGBTs according to the number of the power diodes. The center position of the devices is located in the area corresponding to the power IGBT center line 712 and the device boundary lines 713. Similarly, the outer switch 202 is also placed in the same placement mode. In this way, for different operation modes of the module, the heat distribution of the diode and the switch can be effectively dispersed, and therefore the effect of optimizing the heat dissipation design of the module is achieved.

Similarly, the clamping switches 203/204 can also be arranged in the same manner as the outer switches 201/202, and details are not described herein again.

### Embodiment 2

The ANPC power module disclosed by the embodiment further comprises a module substrate, a packaging part, a power chip and a power loop. The module substrate includes a first surface and a second surface opposite to each other, and is configured to set the ANPC power module. The packaging part comprises a glue filling space, and the glue filling space wraps the power chip and the first surface of the module substrate. The power loop is used for electrically connecting the input end and the output end of the power chip.

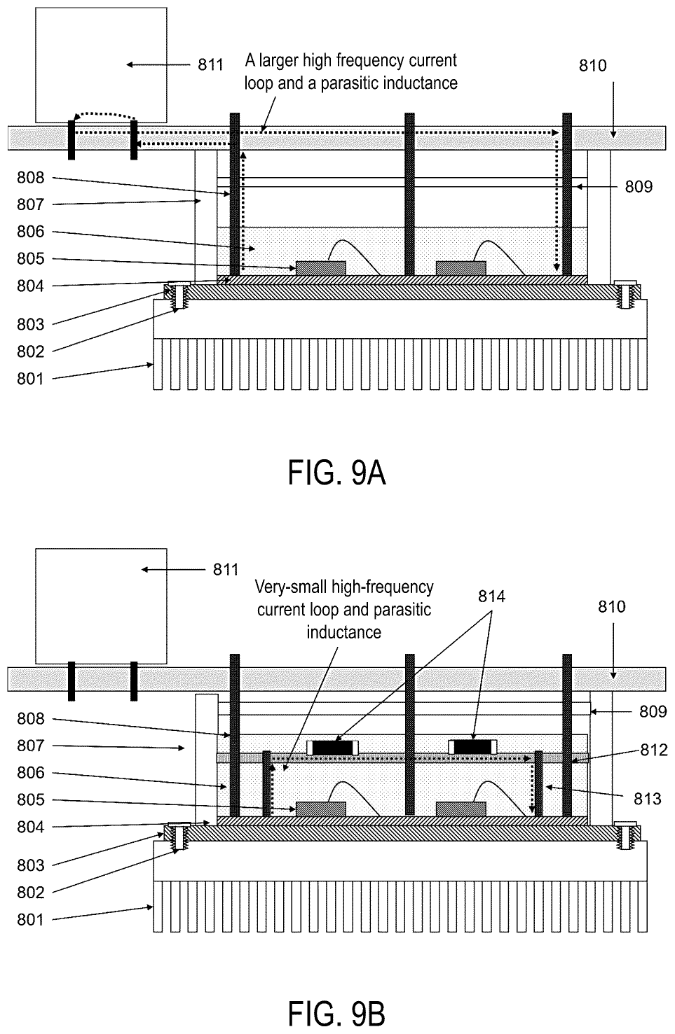

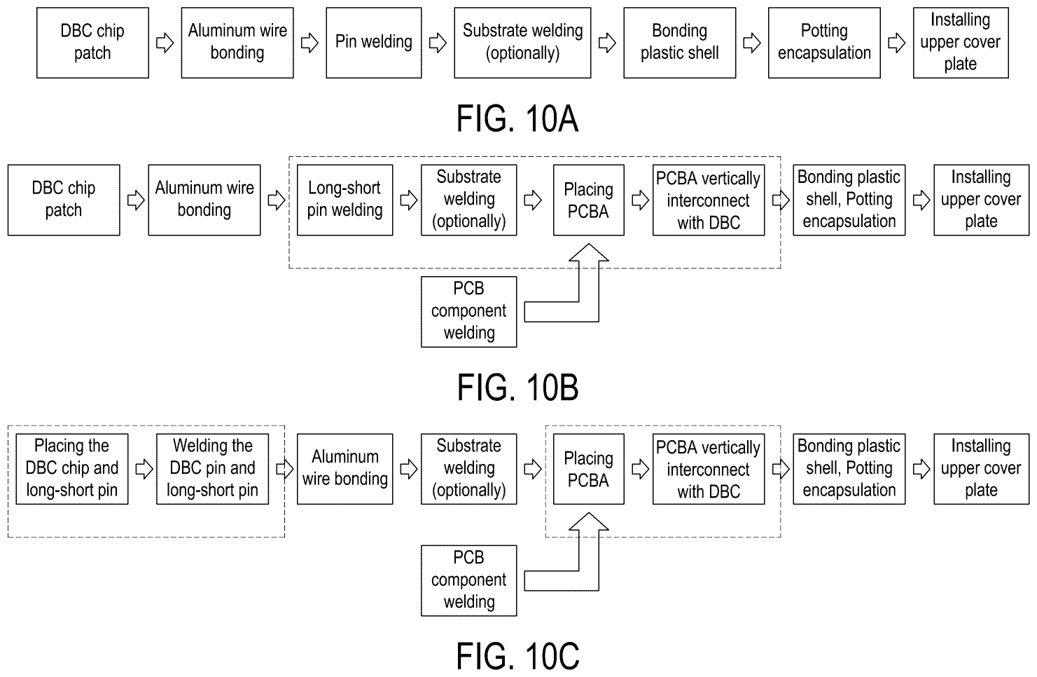

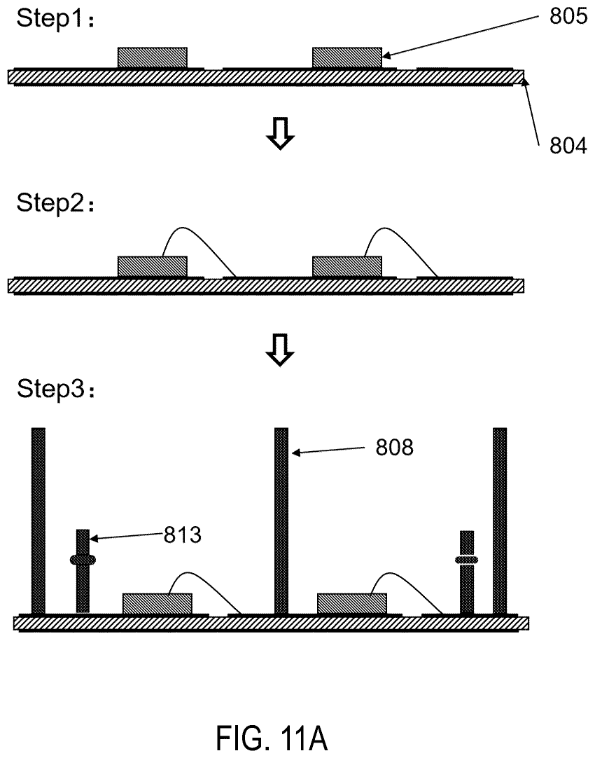

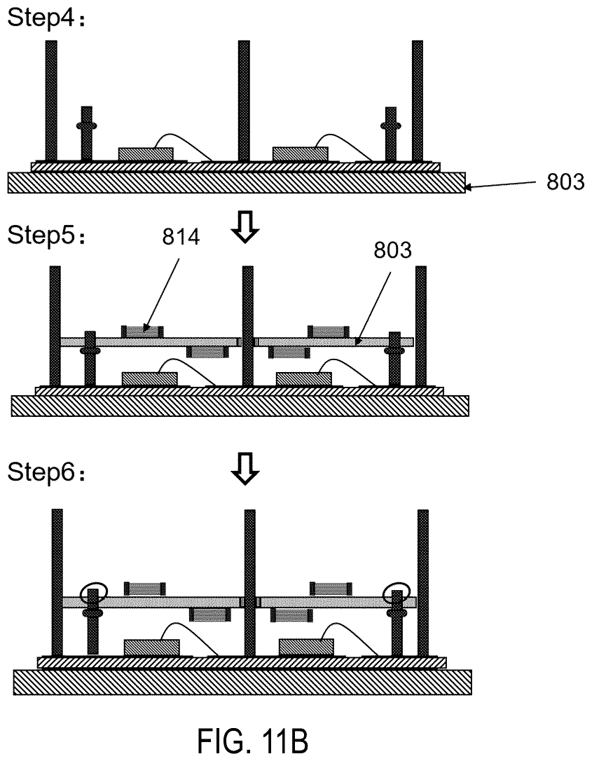

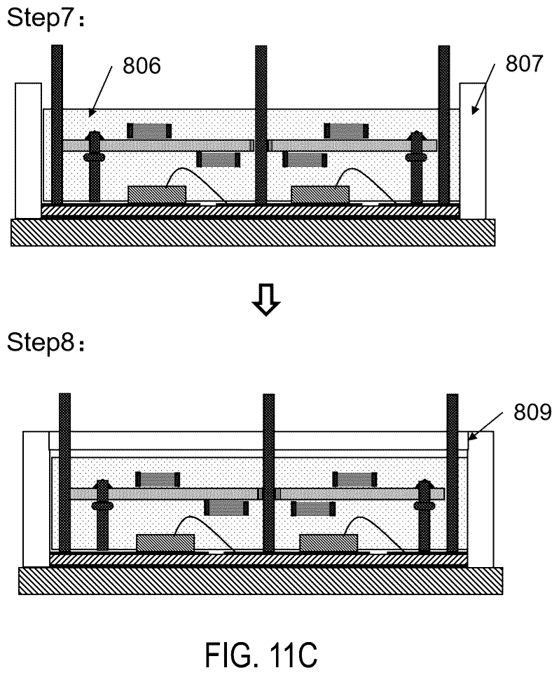

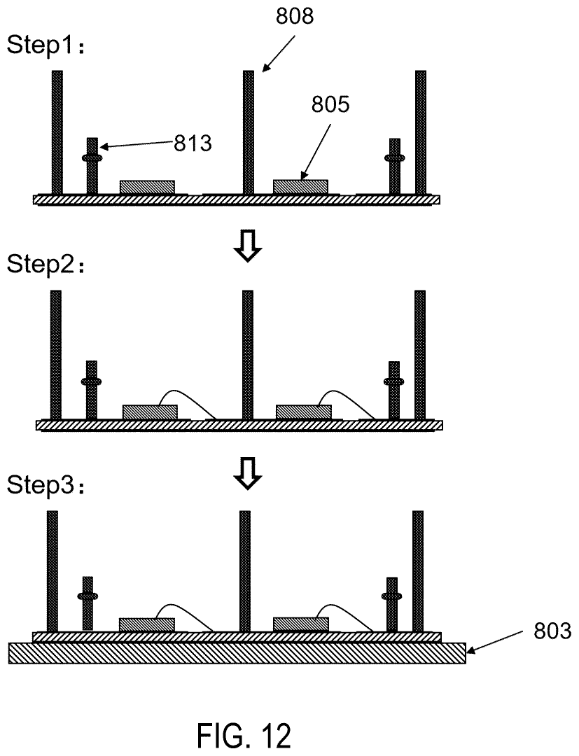

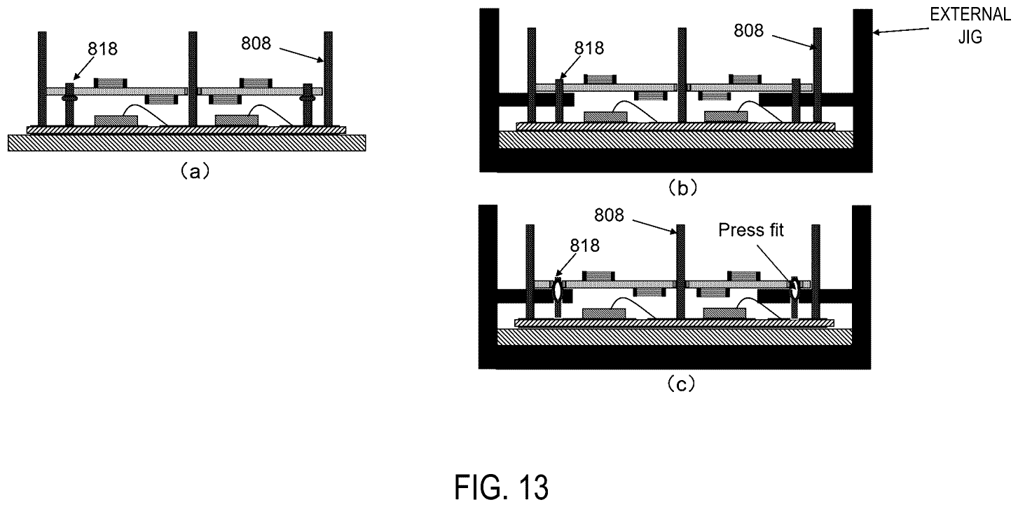

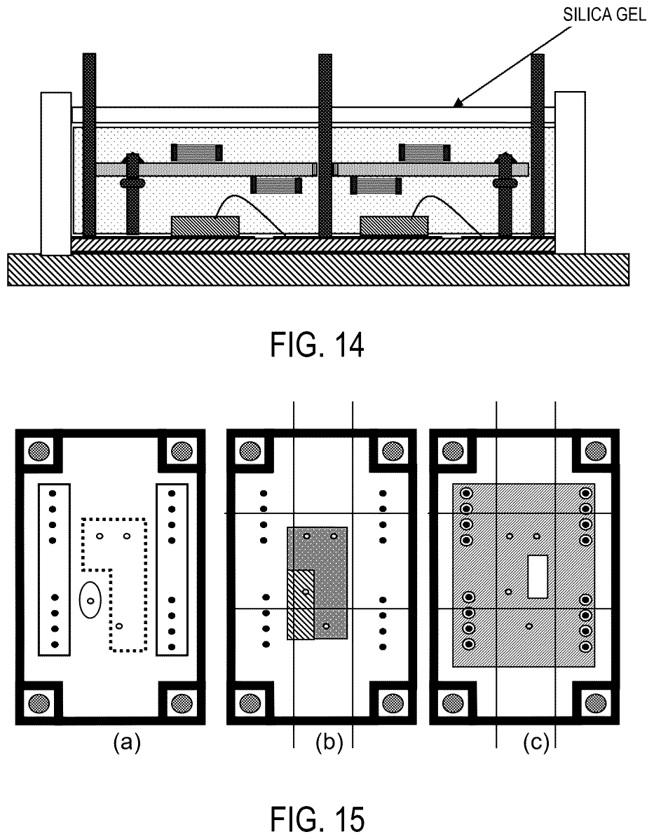

Then, the ANPC power module of the embodiment is described in detail. As shown in FIG. 9A, the ANPC power module comprises an external radiator 801, a module screw 802, a module copper substrate 803, a module DBC 804, a module power chip 805, a glue filling space 806, the module shell 807 (which can be a plastic shell), a module pin 808 and a module upper cover plate 809 an external PCB 810 and an external decoupling capacitor 811. In the embodiment, the module DBC 804 is used as a module substrate, the external PCB 801 serves as a client mainboard, and the module pin 808 serves as a capacitor lead-out terminal (in some other embodiments, the capacitor lead-out terminal further comprise a signal control terminal corresponding to the switch assembly in addition to some power terminals necessary for implementing the circuit function).

The module DBC 804, the module shell 807 and the module upper cover plate 809 are matched to form a packaging part, the packaging part comprises a glue filling space 806, a glue filling space 806 covers the module power chip 805, and the top surface (first surface) of the module DBC 804 and a part of the module pins 808 penetrate through the module upper cover plate 809, so that the module DBC 804 is electrically connected with the external PCB 810. The external radiator 801 and the module copper substrate 803 are connected by means of the module screws 802 (in some other embodiments, the module copper substrate 803 may not be required, and the external radiator 801 may be directly thermally connected to the module DBC 804). An external decoupling capacitor 811 is arranged on the external PCB 810, and the remaining settings are all conventional arrangements. The dotted line in FIG. 9A shows the power loop path of the power module. The ANPC power module has a large high-frequency power loop and a large parasitic inductance, and the loop parameters can be improved through the design of the lead-out terminal in the ANPC module, and the electrical stress of the device is optimized.

In the present embodiment, DBC (insulating ceramic substrate) is used as a module substrate for description. But in other embodiments, other substrates such as a printed circuit board (PCB) can also be used, and the present application is not limited thereto. In addition, when the ANPC power module comprises more than two DBC, certain mechanical stress is generated, the DBC fitting degree is affected. The module copper substrate 803 is arranged under the module DBC 804. The mechanical strength and the heat dissipation effect can be improved, and the bonding consistency under multiple DBC is improved. In addition, in some other embodiments, the capacitor lead-out terminal is also suitable for power modules of a half-bridge, a full-bridge, a three-phase bridge, a TNPC, a DNPC or an INPC.

However, the overall loop parasitic inductance of the ANPC power module shown in FIG. 9A is large and is not suitable for an application scene of high-frequency, high-voltage and large current. As shown in FIG. 9B, a functional board PCBA 812 and a corresponding capacitor lead-out terminal (ie, a short connection terminal—a module inner pin 813) are further added between the module upper cover plate 809 and the module DBC 804. The module inner pin 813 penetrates through the functional board PCBA 812 and is electrically connected with the module DBC 804. According to the embodiment, the high-frequency loop path of the module is greatly reduced, extremely small loop inductance is realized, the voltage spike in the dynamic process can be effectively improved, the actual working voltage range of the module is improved, the impedance and parasitic parameters can be further reduced on the basis of FIG. 9A, the voltage stress of the power device is further improved, and the EMI noise is improved.

The functional board PCBA 812 comprises a printed circuit board (PCB) and components welded on the printed circuit board (PCB). The component disposed on the functional board at least comprises a high-frequency decoupling capacitor 814. The dotted arrow shows a power loop path. Compared with the capacitor lead-out terminal (ie, a long connection terminal—a module pin 808 in the figure) being led out to the external PCB 810, the internal functional board PCBA 812 and the short connection terminal further reduce the length of the loop path. The inductance of the loop path of the embodiment is about 20 nH, and after the internal function board is adopted to improve the design, the inductance of the loop path can be further reduced by 30˜40%.

The high-frequency decoupling capacitor 814 and the module power chip 805 are overlapped as much as possible in the top view direction, that is, vertical electric interconnection is realized, and the capacitor body and the loop path are kept in a straight direction. Preferably, the high frequency decoupling capacitors 814 are all stacked over the module power chip 805. As high-overlapped as possible, it is ensured that the high-frequency filter circuit is minimized and the consistency of each parallel branch is ensured.

Preferably, the functional board PCBA 812 can also comprise an intelligent control-related circuit including a driving circuit, a comparison circuit, a sampling detection circuit, an auxiliary power supply circuit, a protection circuit, and the like.

FIGS. 10A to 10C show flowcharts of several manufacturing methods of the present embodiment.

With reference to FIG. 10A and FIG. 9A, the power module manufacturing method of FIG. 9A comprises:
Steps 1, selecting a module DBC 804, and solder and a module chip 805 are placed for reflow soldering;
Step 2, aluminum wire bonding is carried out on the module chip 805;
Step 3, placing solder through a steel mesh, designing a positioning position and perpendicularity of a control terminal of the needle planting jig, implanting the module pins 808 into corresponding positions, performing reflow soldering, and exiting the jig after completion;
Step 4, a module shell 807 is installed, a sealant is filled between the module shell 807 and the module copper substrate 803 and cured. Residual bubbles in the glue filling hole are removed through vacuum glue filling and curing to form a glue filling space 806;
Step 5, the upper cover plate 809 of the mounting module is disposed and completes the production process.

In the power module shown in FIG. 9B, due to the fact that the functional board and the internal interconnection are added, the manufacturing and assembling process of the functional board PCBA 812 is added in the process. After the aluminum wire bonding or substrate welding link, the functional board PCBA 812 and the power module part need to be interconnected. The interconnection mode is described in detail in the later legend.

A manufacturing method of the power module of FIG. 10B, FIG. 11A to FIG. 11C, and FIG. 9B includes:
Step 1, selecting a module DBC 804, solder and a module chip 805 are placed for reflow soldering;
Step 2, aluminum wire bonding is carried out on the module chip 805;
Step 3: placing solder through a steel mesh, designing a positioning position and perpendicularity of a control terminal of the needle planting jig, implanting a long or short connection terminal (the long connection terminal, namely the module pin 808 and the short connection terminal, namely the inner pin 813 of the module) into a corresponding position, performing reflow soldering, and removing the jig after the reflow soldering is completed;
Step 4: the copper substrate 803 of the welding module, wherein the number of the modules DBC 804 can be one block or a plurality of blocks (the copper substrate involved in the step is only used as an optional material for description, and is not required by the application);
Step 5, a functional board PCBA 812 (equivalent to a printed circuit board for completing component welding) is placed in the module, a perforated PCBA board mounting scheme is selected in FIG. 11B, and a boss of the short needle is used for limiting. When a functional board PCBA is designed, a 3D physical model needs to be established in combination with 3D engineering software to establish a 3D physical model such as a module DBC, a power chip, a functional board PCBA, a copper column and the like. 3D size checking is carried out. In other embodiments, mounting of the functional board PCBA 812 can be carried out in SMT or mechanical plugging mode, and detailed description is subsequently carried out in combination with FIG. 13;
Step 6, the circle position is the bonding point of the welding short connection terminal and the functional board PCBA 812, and the functional board PCBA 812 can be effectively fixedly connected and electrically connected with the module after welding is completed;
Step 7: the module shell 807 is mounted, and a sealant is filled between the module shell 807 and the module copper substrate 803 and cured. Residual bubbles in the glue filling holes are removed through vacuum glue pouring and curing to form a glue filling space 806, and the glue filling height at least needs to be cladded with a functional board PCBA. In other embodiments, other components are further arranged on the functional board PCBA, and then the glue filling space needs to cover components of all the functional board PCBA and the PCB;
Step 8, the upper cover plate 809 of the mounting module completes the production process.

Preferably, as shown in FIG. 10C, when the position of the long and short connection terminals does not interfere with the operation of aluminum wire bonding, the welding of the chip and the terminal can be completed in the same process, and the subsequent technological process is consistent with FIG. 10B.

With reference to FIG. 10C and FIG. 12, another manufacturing method of the power module of FIG. 9B comprises:
Step 1, when the long and short connection terminals do not affect the wire bonding link, the welding steps of the terminal can be moved forwards. Reflow soldering and welding are completed with the module chip 805, and the process mode of terminal placement is unchanged, that is, DBC is selected in step 1-3 in FIG. 11A, and a solder, a chip and a long and short connection terminal are placed;
Step 2, aluminum wire bonding is carried out on the module chip 805;
Step 3: the module copper substrate 803 is welded, wherein the number of the modules DBC 804 is the same as that of the embodiment shown in FIG. 11, and can be one block or a plurality of blocks (the copper substrate involved in the step is only used as an optional material for description, and is not required by the application);

The subsequent steps are the same as Step 5-8 shown in FIG. 11A to FIG. 11C. Similarly, when the position of the capacitor lead-out terminal of the power module of FIG. 9A does not affect the subsequent power chip connection, the step of implanting the capacitor lead-out terminal can also be completed with the power chip welding step.

Next, as shown in FIG. 13, the short connection terminal type and the short connection terminal and the function board installation of the present embodiment are described in detail. A metal terminal is welded on the module DBC 804, in addition to a long connection terminal (a module pin 808) connected with the client application end, the module DBC 804 also needs to be welded with an electrical network function short connection terminal (the module inner pin 818) connected with the internal function board PCBA 812, and the number of the short connection terminals is related to the function requirements required by the module. For example, the module DBC 804 is used for improving the filtering function of the voltage stress of the switch device. The number of terminals with the electrical network function is equal or more than 2.

The functional board PCBA 812 is interconnected with the short connection terminals on the module DBC 804 in the vertical direction, and comprises the modes of wave soldering, selective wave soldering, spot welding or mechanical (such as Press Fit) plug-in connection and the like.

Preferably, the short connection terminal may be a thin copper post with a boss as shown in the (a) of FIG. 13 as a thin copper post with a boss, and the short connection terminal may be interconnected by welding. The application has the advantages that the height-limiting of the PCB can be realized by utilizing the characteristics of the boss without additionally designing a jig.

Preferably, in (b) of FIG. 13, the short connection terminal can also be a curved needle with an S type or a short needle of the same specification as the long connection terminal, and the functional board PCBA is height-limited by means of an external jig, so as to complete insertion or welding, etc., and then remove the jig.

Preferably, in (c) of FIG. 13, the short connection terminal can also be a spring needle in the form of Press Fit. The function board PCBA is height-limited by means of an external jig, and after interconnection such as plugging or welding is completed, the jig is removed.

FIG. 14 is an explicit intention of a cover plate on a module in the application. In the embodiment, the plastic cover plate is used as a module shell to play a role in fixing, surface protection and the like on the surface of the module. In the ANPC power module as shown in FIG. 9B, the functional board PCBA 812 exists in the module, so that the cover plate on the module can be replaced through the combination of the functional board PCBA+silica gel. The fixing effect is achieved through the functional board PCBA 812, the position of the cover plate on the module is cladded with the silica gel, and the dust-proof, moisture-proof and anti-corrosion effects are achieved.

FIG. 15 is a feature description diagram of a long or short connection terminal, a module DBC 804 and a functional board PCBA 812 of the embodiment. The module DBC 804 is welded with a long connection terminal connected with the system application, such as the solid box identification position in the (a) of FIG. 15. In addition, the module DBC 804 is welded with a short connection terminal with an electrical network function and connected to the functional board PCBA 812, such as the terminal in the dashed box of (a) of FIG. 15. Preferably, the DBC substrate can also be welded with some short connection terminals without electrical network functions, such as the solid circle identification position in (a) of FIG. 15. But the total number of the short connection terminals without the electrical network function and the short connection terminals with the electrical network function is not less than 3, so as to realize reliable connection of the fixed function board PCBA 812.

In addition, when the functional board PCBA 812 is interconnected with the module DBC 804, there are the following cases:

1) The shape of the functional board PCBA 812 can be regular or irregular. The functional board PCBA 812 is located in the packaging body of the ANPC power module, and the maximum size does not exceed the contour of the module shell 807.

2) The shape and the placement position of the functional board PCBA 812 must cover an area directly provided with a short connection terminal of the electrical network, and a metallized bonding pad or a via hole is reserved, so that the functional board PCBA 812 can be welded with a short connection terminal provided with an electrical network on the module DBC 804 or other effective connection modes, so that the electrical function connection effect and the fixing effect are realized (as shown in a spot shadow area of (b) of FIG. 15).

3) Based on the above situation 2), the shape and the placement position of the functional board PCBA 812 can further cover the non-functional short connection terminal area, and a bonding pad or a via hole is provided for the short connection terminal, so that the functional board PCBA 812 can be welded with the non-functional short connection terminal or other effective connection modes, and the structural connection strength between the PCBA and the module is further enhanced (as shown in the oblique line shadow area of (b) of FIG. 15).

4) The size of the functional board PCBA 812 needs to avoid all the long connection terminals to the system application board. If the shape and placement of PCB need to cover the part, a hole or a groove needs to be formed in the position of the long connection terminal to avoid assembly interference (as shown in the shadow area in (c) of FIG. 15).

5) The substrate of the module DBC 804 is divided into nine-grids, so that the size of the functional board PCBA needs to have a certain proportion of the opening area (such as greater than 10%) in each nine-grid to ensure that no bubbles remain below the functional board PCBA 812 during vacuum glue filling, as shown in (b) and (c) of FIG. 15. Preferably, in the area of the functional board PCBA 812, an vent with a hole diameter of 0.1 mm is formed every 1 mm, so that the air below the PCB can be effectively removed after glue filling and vacuumizing.

6) According to the complexity of the electrical network, the functional board PCBA 812 can be a single-sided board, a double-panel or a multi-layer board, and the number of layers is not less than 1.

Preferably, the number of layers of the functional board PCBA may be greater than the number of layers actually required, so as to improve the flux, increase the mechanical strength, etc., such as a four-layer board or more layers.

7) At least one type of high-frequency decoupling capacitor is included on the functional board PCBA. The high-frequency decoupling capacitor is connected with the short connection terminal through an electrical network. The loop inductance of the chip is optimized, and the capacitor can be one or a series-parallel combination between capacitors.

8) The functional board PCBA can further increase intelligent functional components such as integrated driving, detection, protection, control and the like, and the intelligent function of the expansion module is realized.

9) The functional board PCBA can support double-sided placement of the front face and the back face of the device, and can also be supported on the same face. Therefore, the PCB supports two-sided or single-sided SMT.

Those skilled in the art can easily understand that the above are only preferred embodiments of the present disclosure, and are not intended to limit the present disclosure. Any modifications, equivalent replacements and improvements made within the spirit and principles of the present disclosure, etc., should be included within the protection scope of the present disclosure.

What is claimed is:

1. An active neutral point clamped (ANPC) power module comprising at least one power module, wherein the power module comprises six switch assemblies, a DC end, a GND end and an SW end, each of the six switch assemblies comprises at least one switch component, the six switch assemblies comprise two outer switches, two inner switches and two clamping switches, each of the DC end comprises a DC positive terminal and a DC negative terminal, each of the two outer switch and the corresponding clamping switch are connected in series to form a switch bridge arm, two ends of the switch bridge arm are electrically connected with the GND end and one DC terminal respectively, wherein a midpoint of each of the two switch bridge arms is electrically connected with a first end of the two inner switches, a second end of the two the inner switches is electrically connected with the SW end,
wherein the at least one switch component comprised in each of the two clamping switches is an IGBT device, the at least one switch component comprised in each of the two outer switches is an IGBT device, and the at least one switch component comprised in each of the two inner switches is a wide-bandgap device,
wherein an additional capacitor lead-out terminal is arranged at an electrical connection of each of the two inner switches and the two switch bridge arms, the capacitor lead-out terminal is used for setting a high-frequency filter capacitor, and two ends of the high-frequency filter capacitor are electrically connected with the capacitor lead-out terminals corresponding to the two switch bridge arms respectively.

2. The ANPC power module of claim 1, wherein an additional diversion lead-out terminal is arranged at the two ends of each of the two switch bridge arms respectively, and the diversion lead-out terminal is used for arranging an additional diversion path outside the ANPC power module,
wherein the diversion path is connected in parallel with an electrical connection path from a switch bridge arm arranged inside the ANPC power module to the GND end, or the diversion path is connected in parallel with an electrical connection path from the switch bridge arm arranged inside the ANPC power module to the DC terminal.

3. The ANPC power module of claim 1, wherein each of the two inner switches comprises a first inner switch and a second inner switch, each of the two switch bridge arms comprises a first switch bridge arm and a second switch bridge arm, the SW end comprises an SW1 end and an SW2 end, one end of the first switch bridge arm is electrically connected with the DC positive terminal, and one end of the second switch bridge arm is electrically connected with the DC negative terminal,
wherein one end of the first inner switch is electrically connected with a midpoint of the first switch bridge arm, and the other end of the first inner switch is electrically connected with the SW1 end; one end of the second inner switch is electrically connected with a midpoint of the second switch bridge arm, and the other end of the second inner switch is electrically connected with the SW2 end.

4. The ANPC power module of claim 3, wherein the DC positive terminal, the GND end and the DC negative terminal are sequentially arranged in a horizontal direction on an upper side of the ANPC power module,
wherein the two outer switches and the two clamping switches are arranged in an array in the horizontal direction, each of the two outer switches is arranged at a position adjacent to the corresponding DC terminal, and each of the two clamping switches is arranged at a position close to the GND end,
wherein the two inner switches are arranged in a row in the horizontal direction, and each of the two inner switches is arranged at a position adjacent to the corresponding switch bridge arm,
wherein the SW end is arranged side by side in the horizontal direction on a lower side of the two inner switches.

5. The ANPC power module of claim 1, wherein at least one of the six switch assemblies comprises at least two switch components, and the at least two switch components included in the same switch assemblies are connected in parallel.

6. The ANPC power module of claim 1, wherein each of the two inner switches comprises a plurality of wide band gap devices in the same inner switch, the wide band gap devices in the same inner switch are connected in parallel, and lengths of an equivalent electrical connection path from each of the wide band gap devices to a corresponding parallel bus point are the same.

7. The ANPC power module of claim 1, wherein each of the two outer switches further comprises at least two power diodes, and the at least two power diodes and the IGBT device in the same outer switch are arranged in a hybrid array.

8. The ANPC power module of claim 7, wherein the hybrid array is arranged in a long-strip-shaped array, and the at least two power diodes are evenly arranged on two sides of the IGBT device in a long direction of a long-strip-shaped.

9. The ANPC power module of claim 2, wherein a number of the diversion lead-out terminal is at least one, and the diversion lead-out terminal is further used for arranging an additional filtering loop outside the ANPC power module.

10. The ANPC power module of claim 1, wherein a number of wide bandgap devices included in each of the two inner switches is multiple, the wide bandgap devices included in the same inner switch are connected in parallel, and a difference of lengths of an equivalent electrical connection paths from each of the wide bandgap devices to a corresponding parallel bus point does not exceed 20%.

11. The ANPC power module of claim 1, wherein the at least one switch component included in each of the two inner switches further comprises an IGBT device, and the at least one switch component included in each of the two outer switches, the two clamping switches and the two inner switches are also connected respectively with a power diode in parallel.

12. The ANPC power module of claim 11, a number of the IGBT devices included in each of the two inner switches is multiple, the IGBT devices included in the same inner switch are connected in parallel, and lengths of an equivalent electrical connection path from each of the IGBT devices to a corresponding parallel bus point are the same.

13. The ANPC power module of claim 11, a number of the IGBT devices included in each of the two inner switches is multiple, the IGBT devices included in the same inner switch are connected in parallel, and a difference of lengths of an equivalent electrical connection paths from each of the IGBT devices to a corresponding parallel bus point does not exceed 20%.

14. The ANPC power module of claim 1, further comprising:
a module substrate, comprising a first surface and a second surface which are opposite to each other;
a power chip, comprising an input end and an output end, wherein the power chip is arranged on the first surface of the module substrate;
a packaging part, comprising a glue filling space, wherein the glue filling space wraps the power chip and he first surface of the module substrate; and
a power loop, used for electrically connecting the input end and the output end of the power chip.

15. The ANPC power module of claim 14, wherein the power loop comprises a vertical loop and a connection loop, and the vertical loop is used for supporting, fixing and connecting the connection loop.

16. The ANPC power module of claim 15, wherein the power loop is arranged in the glue filling space, the connection loop comprises a functional board, the vertical loop comprises the capacitor lead-out terminal, and the capacitor lead-out terminal comprises a long connection terminal and a short connection terminal,
wherein the functional board is arranged above the first surface of the module substrate, the short connection terminal penetrates through the functional board, the functional board is connected with the module substrate, the long connection terminal penetrates through a module cover plate, and the client mainboard is connected with the module substrate,
wherein the functional board comprises a high-frequency decoupling capacitor or a high-frequency filtering capacitor.

17. The ANPC power module of claim 16, wherein the short connection terminal comprises a first short connection terminal, the first short connection terminal is used for realizing electrical connection, and a position of the functional board is cladded with the first short connection terminal in a vertical direction.

18. The ANPC power module of claim 17, wherein the short connection terminal further comprises a second short connection terminal, the second short connection terminal is not used for electrical connection, and the position of the function board is further cladded with a second short connection terminal in the vertical direction.

19. The ANPC power module of claim 16, wherein the module substrate is divided into nine-grid, and areas of each of the nine-grid are equal,
wherein in the vertical direction, the functional board is provided with an opening hole in a region corresponding to each of the nine-grid, and an area of the opening hole is not less than 10% of an area of each of the nine-grid.

20. The ANPC power module of claim 16, wherein a boss is arranged in a central section of the short connection terminal, and the boss is used for supporting the functional board.

21. The ANPC power module of claim 15, wherein the connection loop comprises a client mainboard, and the vertical loop is the capacitor lead-out terminal,
wherein the capacitor lead-out terminal is used for electrically connecting the client mainboard and the module substrate.

22. A manufacturing method of the ANPC power module according to claim 14, comprising the following steps:
Step 1: providing a substrate and the ANPC power module;
Step 2: connecting the ANPC power module with the substrate;
Step 3: installing a module shell, filling the glue between the module shell and the substrate, and removing bubbles and curing to form a glue filling space; and
Step 4: mounting a module cover plate to the ANPC power module.

23. The manufacturing method of claim 22, further comprising the following step before the step 3:
providing a heat conducting connecting plate, wherein the heat conducting connecting plate is arranged below the substrate, and the heat conducting connecting plate is welded to be fixedly and thermally connected with the substrate.

24. The manufacturing method of claim 22, wherein the step 2 comprises:
firstly, arranging the capacitor lead-out terminal at a corresponding position to be welded, and then arranging the power chip at a corresponding position to be welded; or
firstly, arranging the power chip of the ANPC power module at a corresponding position to be welded, and then arranging the capacitor lead-out terminal of the ANPC power module at a corresponding position to be welded; or
arranging the power chip of the ANPC power module and the capacitor lead-out terminal of the ANPC power module at corresponding positions and then to be welded together.

25. A manufacturing method of the ANPC power module of claim 16, comprising the following steps:
Step 1: providing a substrate, a power chip and the capacitor lead-out terminal;
Step 2: respectively connecting the substrate, the power chip and the capacitor lead-out terminal;
Step 3: providing a functional board, and welding the functional board and the short connection terminal;
Step 4: mounting a module shell, filling a glue between the module shell and the substrate, removing bubbles and curing to form a glue filling space, wherein the height of the glue filling space at least covers the functional plate; and
Step 5: mounting the module cover plate to form the ANPC power module.

26. The manufacturing method of claim 25, further comprising the following step before the step 4:
providing a heat conducting connecting plate, wherein the heat conducting connecting plate is arranged below the substrate, and the heat conducting connecting plate is welded to be fixedly and thermally connected with the substrate.

27. The manufacturing method of claim 25, wherein the step 2 comprises:
firstly, arranging the capacitor lead-out terminal at a corresponding position to be welded, and then arranging the power chip at a corresponding position to be welded; or
firstly, arranging the power chip at a corresponding position to be welded, and then arranging the capacitor lead-out terminal at a corresponding position to be welded; or
arranging the power chip of the ANPC power module and the capacitor lead-out terminal of the ANPC power module at corresponding positions and then to be welded together.

28. The manufacturing method of claim 25, wherein the manufacturing method is applied in a half-bridge, full-bridge, three-phase bridge, TNPC, DNPC or INPC power module.

29. An operating method of the ANPC power module according to claim 1, wherein the capacitor lead-out terminal is applied in a half-bridge, full-bridge, three-phase bridge, TNPC, DNPC or INPC power module.

30. An operating method of the ANPC power module according to claim 1, wherein the two ends of at least one high-frequency filter capacitor are electrically connected with the capacitor lead-out terminals of the power module respectively, the equivalent capacitance of the high-frequency filter capacitor is at least C, and C meets the formula (1):
$$\frac{1}{2} {LI}^{2} = \frac{1}{2} {CU}_{MAX}^{2} - \frac{1}{2} {CU}^{2} \qquad ( 1 )$$
L is an equivalent inductance of a power loop when the ANPC power module is applied, i is a current value at the turn-off moment, Umax is a maximum voltage value, and U is a working voltage value.
